(19) United States
(12) Patent Application Publication
(10) Pub. No.: US 2012/0138806 A1
(43) Pub. Date: Jun. 7, 2012

(54) NOVEL RADIATION DETECTOR

(76) Inventors: Christopher John Holmes, Warrington (GB); Steven John Stanley, Warrington Cheshire (GB)

(21) Appl. No.: 13/389,137

(22) PCT Filed: Aug. 10, 2010
(86) PCT No.: PCT/GB2010/051324

§ 371 Date: Feb. 6, 2012

(30) Foreign Application Priority Data
Aug. 10, 2009 (GB) 0913861.1

(51) Int. Cl. G01T 1/20; G01T 1/00

(52) U.S. Cl. 250/369; 250/483.1

(57) ABSTRACT

The invention provides a device for the detection of elevated levels of radiation in remote locations, the device comprising a scintillator crystal and a variable length fibre optic cable. Preferably, the scintillator comprises an inorganic scintillator and the fibre optic cable comprises a metal coated fibre optic cable. The device preferably also comprises a light measurement device which co-operates with recording means such that the radiation levels of the environment in which the device is deployed may be determined. The device has potential widespread application in the nuclear industry, for the monitoring of products, processes and/or facilities that exhibit very high levels of radiation.

### FIELD OF THE INVENTION

The present invention is concerned with the detection of radiological hazards. More specifically, it relates to a novel device that can be successfully operated in high levels of radiation in order to record the intensity of radiological hazards.

### BACKGROUND TO THE INVENTION

Numerous applications exist for techniques which are capable of detecting and measuring the presence of radiation. Such techniques find particular application in the detection and characterisation of potential radiation hazards in the nuclear and related industries.

US-A-2009/0014665, for example, discloses a dosimeter for radiation fields which includes a scintillator, a light pipe having a first end in optical communication with the scintillator, and a light detector. The light pipe may have a hollow core with a light reflective material about its periphery, and the dosimeter may further include a light source that generates light for use as a calibrating signal for a measurement signal and/or for use to check the light pipe. The device finds particular use in medical applications.

Prior art devices such as this, however, suffer from several disadvantages. Most significantly, several systems—and particularly those associated with radiation therapy applications—demonstrate an inability to perform in high radiation backgrounds. Other common difficulties include practical problems in deployment, due to physical spatial constraints or the remoteness of locations in which investigations are to be performed. Furthermore, cost issues are often highly significant, with many commercially available systems typically being expensive to purchase.

In an attempt to address these issues, and to provide a system which performs effectively and efficiently in high radiation backgrounds, which may be deployed in a wide variety of locations and circumstances, and which is relatively cheap and easy to manufacture, WO-A-2009/063246 disclosed a device for the detection and mapping of radiation emitted by radioactive materials, the device comprising a polymeric core located within an external shell material, the polymeric core comprising at least one radiation sensitive component which is sensitive to the radiation emitted by the radioactive materials and the external shell comprising a collimation sheath. The radiation sensitive core component is sensitive to gamma-radiation, and preferably also sensitive to beta-radiation and neutron radiation.

U.S. Pat. No. 5,640,017 teaches a device for the remote detection of radiation which has an optical fibre, a detecting crystal, one end of which is optically coupled to the optical fibre and which is able to emit, by interacting with the radiation, a light which then propagates in the optical fibre, as well as an optical cladding surrounding the detecting crystal which is in optical contact with, and has an optical index lower than, the detecting crystal, so as to confine the light by total reflection. The device finds application in dosimetry.

The use of real-time fibre optic radiation dosimeters for nuclear environment monitoring around thermonuclear reactors has also been considered by A. F. Fernandez et al, Fusion Engineering and Design Journal (2008), 83, 50-59.

U.S. Pat. No. 4,471,223 relates to a method and apparatus for determining the position of a liquid/liquid or liquid/vapour interface in a remote inaccessible location, for example in undersea oil storage tanks, by exposing the liquids or liquid and vapour to gamma-radiation from a source adjacent or within the vessel containing the liquid(s), monitoring the gamma-radiation issuing from the liquids or liquid and vapour, and using long lengths of optical fibre to convey the signals received to a measuring instrument.

U.S. Pat. No. 6,087,666 is concerned with a radiation sensitive optically-stimulated luminescent dosimeter system for the remote monitoring of radiation sources. The system comprises a dosimeter which utilises a doped glass material disposed at a remote location for storing energy from ionising radiation when exposed thereto, and for releasing the stored energy in the form of optically-stimulated luminescent light at a first wavelength when stimulated by exposure to light energy at a stimulating second wavelength. The system further includes an optical source for providing stimulating light energy at the stimulating second wavelength, a photodetector for measuring optically-stimulated luminescent emissions, and an optical fibre for passing the stimulating light energy from the optical source to the dosimeter to stimulate the dosimeter to produce optically-stimulated luminescence light from stored energy and for passing the luminescence light to the photodetector to enable it to measure any optically-stimulated luminescent emissions occurring when the dosimeter is excited by the light energy at the stimulating second wavelength. The dosimeter can also be used for real-time monitoring by detecting the scintillations emitted by the doped glass material on exposure to ionising radiation.

U.S. Pat. No. 5,323,011 describes an ionising radiation detector which employs optical fibres as the medium for sensing ionising radiation emitted by a radioactive source. Light in the infrared region is pumped continuously through an optical fibre located in an area or region where the unintentional discharge of ionising radiation may be expected, so that such emission is immediately detected. The source of optical light emits a constant output within a specific wavelength band which changes only when irradiation of the fibres by ionising radiation causes their internal colour centres to change. The output of the fibres is optically coupled to a photomultiplier via a light pipe, and a single light source, detector, and associated electronics complete the system. The device may comprise a hand-held unit for remote sensing, such that the components are located at a point remote from the position liable to be subjected to radiation exposure.

However, whilst these devices overcome many of the difficulties associated with the detection of radiation in remote locations, and can also be operated successfully in many high radiation situations, they are still not able to operate in environments which display very high levels of radiation, typically involving dose rates in the range of tens of thousands of Sieverts/hour. Consequently, there is still a need for the development of a device which is capable of operating accurately and successfully in such situations, and it is this necessity which is addressed by the present invention.

### SUMMARY OF THE INVENTION

Thus, in accordance with a first aspect of the present invention there is provided a device for the detection of elevated levels of radiation in remote locations, said device comprising a scintillator and a variable length fibre optic cable, wherein said scintillator is an inefficient inorganic scintillator having a scintillation efficiency of less than 20,000 photons per MeV.

Preferred scintillators have a scintillation efficiency of less than 15,000 photons per MeV, more especially in the range from 5,000-12,000 photons per MeV.

Particularly preferred examples of suitable inorganic scintillators comprise non-hygroscopic materials which also show advantageous physical properties such as high density, low compressibility and high radiation tolerance. Typically, density values fall in the range of from 2.5 to 15 g/cm³, preferably from 4 to 10 g/cm³. Especially suitable examples include materials having a short afterglow, such as zinc-based scintillators, a typical example of which is zinc tungstate (ZnWO₄), which has a density of 7.62 g/cm³.

The scintillator preferably comprises a scintillating crystal, and said crystal is coupled to the fibre optic cable to allow for remote deployment, thereby providing a real-time radiation detection device adapted to operate in the elevated levels of radiation which are frequently encountered in the nuclear industry. Typical radiation levels would result in dose rates of the order of tens of thousands of Grays/hour. Thus, the device is adapted to be deployed in radiation environments which generate dose rates in the region of 0.1 mGy/hr to 100,000 Gy/hr, more generally 10 mGy/hr to 10,000 Gy/hr.

The fibre optic cable for remote deployment has a length which can typically vary in the range from 1 to 500 m, preferably 5 to 100 m, but which is typically in the region of 20 m.

Preferably, the fibre optic cable comprises a metal coated silica-based fibre optic cable but, optionally, may comprise a polymer optical fibre cable.

The device according to the first aspect of the invention preferably also comprises a light measurement device such as a photomultiplier-based system or, more preferably, a charged coupling device (CCD) camera, which co-operates recording means, typically comprising PC software. In a particularly preferred arrangement, a CCD camera co-operates with software in such a way that scintillation light produced from the crystal in a radiation field is transmitted down the fibre optic cable, detected by the CCD camera, and recorded on the software, such that the radiation levels of the environment in which the device is deployed may be determined. Said camera may be adapted to receive information from multiple detection devices.

The small, compact nature of the device allows it to be utilised in small access spaces. Furthermore, the devices according to the invention may be deployed either as single detectors, as chains of detectors, thereby facilitating radiation monitoring along vertical or horizontal lines, or as arrays of detectors which may be placed over a designated environment in order to facilitate the shaping of the exact contours of an object under evaluation by means of radiation monitoring. Thus, in said embodiments, multiple detectors may be attached to a single camera by means of separate ports on the camera, with a separate port being provided for each detector. Further embodiments of the invention envisage the use of a multiplicity of detectors in combination with multiple cameras.

The device according to the first aspect of the invention may successfully be deployed in underwater environments, for example nuclear fuel storage ponds, at depths of around 25 m, and also finds application in the evaluation of radiation levels underground and in soil samples, by deployment down boreholes of similar depths.

Due to its straightforward design, the device according to the first aspect of the invention is relatively cheap to produce, and its mode of deployment ensures that operatives are exposed to reduced levels of radiation. Consequently, in addition to its efficiency in operation, the device offers significant advantages in term of cost and health and safety considerations. The device has potential widespread application in the nuclear industry, for the monitoring of products, processes and/or facilities that involve the processing, storage or movement of intermediate and high level wastes.

According to a second aspect of the present invention, there is provided a method for the detection of elevated levels of radiation in remote locations, said method comprising:

(a) providing a device according to the first aspect of the invention;

(b) exposing said device to radiation such that scintillation light produced from the scintillator is transmitted down the fibre optic cable;

(c) detecting the scintillation light by means of a light measurement device which co-operates with PC software;

(d) recording the camera output on the software; and

(e) determining the radiation levels of the environment in which the device is deployed.

### BRIEF DESCRIPTION OF THE DRAWINGS

Embodiments of the invention are further described hereinafter with reference to the accompanying drawings, in which:

FIG. 1(a) is a side view of a device according to a preferred embodiment of the invention;

FIG. 1(b) is an end view of a device according to a preferred embodiment of the invention; and

FIG. 1(c) is a plan view of a device according to a preferred embodiment of the invention.

### DESCRIPTION OF THE INVENTION

The present invention provides a device for the real-time, remote detection of radiation. Most particularly, the invention facilitates the detection of radiation in environments which comprise elevated levels of gamma-radiation, as seen most particularly in parts of the nuclear industry.

The device comprises an inorganic scintillator coupled to a variable length fibre optic cable. Preferably, said scintillator is securely mounted at one end of said fibre optic cable. Optical fibre is particularly suited to the present application as it has the advantage of being able to transmit light over considerable distances with low energy losses. Light produced from the crystal when the device is exposed to a radiation field is transmitted down the fibre optic cable, and may then be detected by a charged coupling device (CCD) camera and recorded on PC software.

Particularly preferred inorganic scintillators comprise zinc-based scintillators, with zinc tungstate crystals being an especially preferred example. A suitable inorganic zinc tungstate (ZnWO₄) crystal may be obtained from Hilger Crystals and typically comprises a rod-like cuboid structure having dimensions in the ranges from 5 mm to 100 mm (length), 0.1 mm to 5 mm (width) and 0.1 mm to 5 mm (depth), with preferred ranges being from 10 mm to 50 mm (length), 0.5 mm to 2 mm (width) and 0.5 mm to 2 mm (depth). In a particularly preferred embodiment of the invention a crystal is employed having dimensions of 20 mm×1 mm×1 mm.

Preferably, the crystal is encased in wrapping means, adapted to allow random light to enter and exit the crystal. Preferred wrapping means comprises a diffuser/reflector sheet which optimally is white.

In preferred embodiments, the crystal is encased in fixed shielding means, in order to provide enhanced radiation resistance and protection during deployment of the device, and thereby improve the collection of scintillated light. Preferably, said fixed shielding means comprises a metallic sheath, and more preferably comprises a metal which may be easily machined, such as aluminium or copper. Most preferably, the sheath is formed of aluminium. Preferably, the sheath has a thickness in the range from 0.1 mm to 1.0 cm, more preferably between 0.2 mm and 0.5 mm.

In particularly preferred embodiments of the invention, at least a part of the scintillating crystal is covered with moveable shielding means, adapted to selectively shield at least a part of the crystal from radiation and to provide anti-collimation, thereby facilitating directional radiation detection. Preferably, said moveable shielding means comprises a high density metal which may be readily machined. Particularly preferred metals in this context comprise lead and tungsten. Typically, said moveable shielding means is adapted to move independently of said scintillator crystal and said fibre optic cable and, most conveniently, is cylindrical in shape. In preferred embodiments, movement of said moveable shielding means may be effected by means of a manipulation system comprising a lever-operated hinged arrangement adapted to set the in-plane position of the moveable shielding means, coupled with a further means to set the rotational position of the moveable shielding means. In alternative embodiments of the invention, the moveable shielding means may be positioned using automated mechanical means consisting of one or more programmable stepping motors.

Most preferably, said moveable shielding means comprises a cylindrical member having a length of from 2 mm to 25 cm, preferably 1 cm and 15 cm, more preferably between 5 cm and 10 cm, and a diameter of from 2 mm to 5 cm, preferably 5 mm to 3 cm, more preferably in the region of 1-2 cm.

In certain embodiments of the invention, the device according to the first aspect of the invention may comprise moveable shielding means comprising laser locating means, said laser locating means being adapted to provide a user with a visible indication of the direction in which the moveable shielding means is pointed and, therefore, the direction from which any external incident radiation is being blocked from contact with said scintillating crystal. Optimally, said laser locating means comprises a laser pointer.

Thus, in a typical embodiment of the invention, the scintillator may be fitted with an anti-collimation device which comprises a radiation shield in the form of a tungsten cylinder, adapted to provide a directional aspect to the results which are obtained, such that these results will indicate the direction, relative to the position of the device of the invention, from which the radiation originates. In said embodiment, the scintillator crystal may be fitted to the end of a deployment lance comprising the tungsten cylinder fitted to a hinge to allow the cylinder to move around the scintillator crystal centre. The position of the tungsten cylinder in terms of the angle to the axis of the lance)(0-90° and the rotational angle)(0-360° can be adjusted manually or remotely once the device is in position so that, when the tungsten cylinder is in line with the radiation source, the reading obtained from the device will be minimised, thereby providing an indication of the source location.

The fibre optic cable is comprised of an optical fibre which preferably comprises a silica fibre. Most preferably, the optical fibre comprises a silica core and silica cladding. In a particularly preferred embodiment of the invention, the chosen cable is a multimode step-index silica-silica fibre having a high purity synthetic silica core and doped silica cladding. Preferably, the optical fibres are coated with a metal which may be easily machined, such as aluminium, copper or gold. Particularly preferred optical fibres are those having a coating of aluminium or copper. Suitable optical fibres may be obtained from Oxford Electronics under the trade name of CuBALL.

Optionally, said fibre optic cable may comprise a polymer optical fibre cable. Preferred polymer optical fibre cables comprise polymeric materials such as poly(methyl methacrylate), polystyrene, or mixtures thereof.

For optimum performance, it is necessary that the optical fibres should be wide spectrum UV visible, such that they are able to optimally transmit the wavelength of the scintillation light produced by the scintillating crystal, and that they should transmit light in a wavelength range which is aligned with the wavelength of the emitted light from the inorganic scintillator crystal. Thus, in the case of a zinc tungstate crystal the optical fibres are required to transmit light having a wavelength range from 180 to 1200 nm.

The fibre optic cable is also required to show very high resistance to degradation caused by irradiation, and analysis of the transmission spectra of the preferred metal coated silica fibres has shown no measurable degradation of the fibres following irradiation at levels of 0.3 kGy to 55 kGy.

Preferably, the fibre optic cable is cased in a sheath in order to provide radiation and damage resistance during deployment. Such an arrangement also has the advantage of enhancing the rigidity to the device, and thereby improving ease of use, for example in terms of the ability to feed the device through small access holes in process equipment. Preferred sheaths are formed of metals which may be easily machined. Most preferably, said sheaths are formed of copper.

Generally, metal coated fibres are able to operate at high temperatures, and typically will withstand temperatures of up to 700° C. for short periods of time of 1 hour or less, whilst operation in temperatures of up to 500° C. for much longer periods of up to several hours (e.g. 12-24 hours) is possible. The fibres also show improved hermeticity properties and higher strength when compared with, for example, silica-based optical fibres coated with polymers.

The diameter of the optical fibre is selected so as to provide the closest surface area coverage of the fibre in contact with the end of the crystal. Thus in the case of the crystal having the most preferred dimensions (1 mm square), the dimensions of the core diameter and cladding diameter are preferably both in the range from 800 to 1200 μm, more preferably from 900 to 1100 μm, whilst the coating diameter preferably ranges from 1000 to 1600 μm, more preferably from 1100 to 1500 μm, and the fibre has a numerical aperture which preferably falls in the range from 0.1 to 0.4, more preferably from 0.15 to 0.3. In a particularly preferred embodiment of the invention, the dimensions of the core diameter, cladding diameter and coating diameter are 1000 μm, 1060 μm and 1320 μm respectively, whilst the fibre has a numerical aperture of 0.22±0.02.

In instances where very high radiation levels are encountered, there is a requirement to reduce the efficiency of the detector. In such situations the diameter of the fibre optical cable may be reduced in order to achieve this effect. Thus, in further embodiments of the invention, the dimensions of the core diameter and cladding diameter are preferably both in the range from 400 to 800 μm, more preferably from 500 to 700 μm, whilst the coating diameter preferably ranges from 500 to 1000 μm, more preferably from 600 to 900 μm, and the fibre has a numerical aperture which preferably falls in the range from 0.1 to 0.4, more preferably from 0.15 to 0.3.

Coupling of one end of the fibre optic cable to the scintillating material is generally achieved by gently pressing the fibre into the end of the crystal, thereby causing slight embedment. Subsequently, the fibre is preferably held in tight contact with the crystal by the use of securing means, which is clamped into place so as to hold the two elements together and thereby maintain the integrity of the optical contact between the optical fibre and the scintillating crystal. Most conveniently the metallic sheath used as the fixed shielding means for the scintillating crystal, which is formed of e.g. aluminium, may be used for this purpose. Thus, in preferred embodiments, the fixed shielding means which encases the inorganic scintillator also serves as the securing means.

The device of the invention preferably also comprises a charged coupling device (CCD) camera as the light detector, adapted to co-operate with suitable PC software which serves as the recording means. A preferred example of such a camera is a Hamamatsu Digital Charged Coupling Device (CCD) Board Camera (09260-921-11/12/13), which is a back-thinned, Full Frame Transfer CCD image sensor of 16 bit digital output. This camera and the captured digital image signal are controllable by an IEEE 1394 bus interface, such that the device and its supporting software can be operated from a desktop or laptop PC using SpAn software. The CCD camera or other light detector is coupled to the free end of the fibre optic cable distant from the scintillating material.

In one embodiment of the invention, the camera comprises a multiplicity of discrete ports, thereby facilitating attachment of a multiplicity of separate detectors, which may thereby operate in parallel. As previously noted, the multiple detector concept may be extended by linking multiple detector devices in a linear direction or, alternatively, by linking the devices in a criss-cross pattern to form a net type structure. Thus, the device and method of the invention offer the ability to operate in an array in order to map and monitor large radiation environments via the connection of multiple crystal/fibre optic detectors to the same light detector, in addition to the facility for linking multiple detector devices together in either chain formations or array formations so as to permit radiation detection in 2 and 3-D environments. Typically, a camera may comprise three discrete ports. In certain embodiments of the invention, wherein large numbers of detectors are in operation, it is possible that more than one camera may be in use in combination with the multiplicity of detectors.

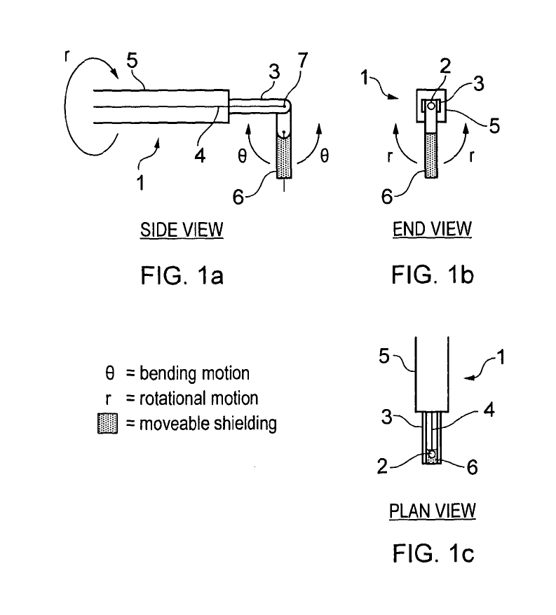

Referring now to the Figures, there are seen in FIGS. 1(a), (b) and (c), side, end and plan views respectively of a device according to a preferred embodiment of the invention, wherein a deployment lance (1) comprises a scintillation crystal (2) located in fixed shielding means (3) coupled to a fibre optic cable (4) encased in a sheath (5). The device further comprises moveable shielding means (6) attached to the end of the deployment lance via hinge (7) so as to facilitate bending motion A about hinge (7). In additional rotational motion r of the deployment lance may be effected.

The device and method according to the invention may be applied to the characterization of different radiation sources. Thus, by analysis of the light curve transmitted down the fibre optic cable from the scintillation crystal and, and subsequently recorded on a CCD camera, and specifically of the curve properties (e.g. width to height ratio), characterisation of different gamma radiation sources may be achieved.

In high radiation environments, it may be the case that the amount of light emitted by the scintillating crystal and transmitted through the fibre optic cable is such that saturation of the light detecting device and recording software may occur. In order to prevent such problems from arising, and to facilitate effective operation of the light recording device in such environments, further embodiments of the invention envisage fibre optic cables which comprise fibre optic light filters. Said fibre optic light filters are attached to the ends of the fibre optic cables which are to co-operate with the light detector prior to coupling of the cable to the detector, and effectively reduce the amount of scintillation light being transmitted to the detector, thereby facilitating effective operation of the device. Typically, said filters are adapted to reduce the fibre optic output light intensity by between 50 and 99.99%, preferably by between 85% and 99.99%, more preferably by between 95 and 99.99%.

Thus, the detector and method of the present invention offer the ability to make real-time readings in areas of elevated levels of radiation in the nuclear industry and facilitate remote deployment operation, such that data acquisition may be conducted at a safe distance from the radiation source. The device can be deployed as a single detector, a chain, or an array configuration. thereby increasing the radiation monitoring area and, in view of its compact size, is capable of accessing small spaces. Hence, the device may find application in radiation mapping in horizontal and vertical lines when deployed in chain formation, and radiation mapping around the contours of process equipment when deployed in an array formation. Furthermore, the device is sufficiently cost effective to be used as a sacrificial and/or reusable device.

In the method according to the second aspect of the invention, the device according to the invention is placed in a location to be investigated. The device may simply be placed manually by an operator, or remotely by means of a manipulator or remote arm. In further embodiments, the invention envisages the use of a purpose built mechanical device for such purposes, for example, when the device is to be deployed in particular physical locations and requires handling in situations such as through a cave wall, or when suspended from a device such as a crane. Most conveniently, the device may be manipulated into position in such situations by means of MSM (master slave manipulator) operator arms.

Previous means for undertaking these sorts of measurements had generally involved the use of hand held dosimeters. However, the hand held devices may not be used in high radiation backgrounds, due to concerns for the safety of operatives, and are of limited value in confined spaces, since operatives may not be able to access these areas. The device of the present invention does not suffer from these disadvantages.

The device and method of the present invention typically find application in the nuclear industry, for such as pre-decontamination operations, by facilitating location, measurement and mapping of radiation hazards in nuclear facilities where there may be reduced access due to confined space, and where there are generally unacceptably high background radiation levels which are above the level that would allow for safe access. The technology can thus be used for the detection, measurement and mapping of radiation on nuclear plants and in gloveboxes, cells, confined spaces, and other radioactive environments confined by shielding, for example between two or more containment walls on a nuclear storage facility or in military facilities following radiation release. Hence, the device and method have potential use in many military and security related applications.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

The invention will now be further illustrated, though without in any way limiting its scope, by reference to the following examples.

### EXAMPLES

### Example 1

The device according to the invention has been successfully deployed on the breakdown cell of a line in the Highly Active Waste Vitrification Plant (WVP) on the Sellafield site of the UK Nuclear Decommissioning Authority. During calibration, the device was shown to be sensitive over the radiation range of 0.01 to 8580 Gy hr⁻¹. The upper radiation limit of the device is believed to be in the region of 100,000 Gy hr⁻¹. Calibration of three separate devices was successfully carried out using sealed ⁶⁰Co and ¹³⁷Cs sources and a high level of consistency was observed in the total count rates observed with each of the devices.

### Example 2

A device according to the invention was employed for the mapping of radiation intensities over a given volume within the breakdown cell of a line in the WVP. The device was posted into the breakdown cell via an existing access point. More specifically, the device was deployed into the cell using an existing traverse consisting of a tube of approximately 30 mm diameter adapted to feed wires from the cell face into the cell. Subsequently, the device was engaged by a Master Slave Manipulator (MSM) and manoeuvred around the breakdown cell to a number of heights and depths, thereby providing multiple point measurements of radiation intensity.

The device was then left in position for a period of 24 hours, after which time re-testing indicated that there was no detrimental effect to the device or the recorded results. The device was subsequently allowed to remain in situ for a further 2 weeks, following which re-testing provided similarly encouraging results.

1.-44. (canceled)

45. A device for the detection of elevated levels of radiation in remote locations, said device comprising a scintillator and a variable length fibre optic cable, wherein said scintillator comprises an inorganic scintillator crystal having scintillation efficiency of less than 20,000 photons per MeV., optionally less than 15,000 photons per MeV, optionally in the range from 5,000-12,000 photons per MeV, wherein said elevated levels of radiation optionally comprise elevated levels of gamma-radiation.

46. The device as claimed in claim 1, wherein said inorganic scintillator crystal comprises a non-hygroscopic material with a density which falls in the range of from 2.5 to 15 g/cm³.

47. The device as claimed in claim 1, wherein said inorganic scintillator comprises a zinc-based scintillator, wherein said zinc-based scintillator optionally comprises zinc tungstate (ZnWO₄).

48. The device as claimed in claim 1, wherein said levels of radiation are in the range of 0.1 mGy/hr to 100,000 Gy/hr, optionally in the range of 10 mGy/hr to 10,000 Gy/hr.

49. The device as claimed in claim 1, wherein the length of said fibre optic cable varies in the range of from 1 to 500 m, optionally in the range of from 5 to 100 m, and is optionally in the region of 20 m.

50. The device as claimed in claim 1, further comprising a light measurement device which comprises at least one charged coupling device (CCD) camera, wherein said light measurement device is optionally adapted to receive information from multiple detection devices.

51. The device as claimed in claim 1, wherein the inorganic scintillator crystal comprises a rod-like cuboid structure having dimensions in the ranges from 5 mm to 100 mm (length), 0.1 mm to 5 mm (width) and 0.1 mm to 5 mm (depth), optionally in the ranges from 10 mm to 50 mm (length), 0.5 mm to 2 mm (width) and 0.5 mm to 2 mm (depth), and are optionally 20 mm×1 mm×1 mm.

52. The device as claimed in claim 1, wherein said crystal is encased in wrapping means comprising a diffuser/reflector sheet.

53. The device as claimed in claim 1, wherein said crystal is encased in fixed shielding means which optionally comprises a metallic sheath formed of aluminium or copper.

54. The device as claimed in claim 1, wherein at least a part of said scintillating crystal is covered with moveable shielding means, adapted to selectively shield at least a part of the crystal from radiation, wherein said moveable shielding means optionally comprises lead or tungsten and wherein the position of the moveable shielding means can optionally be adjusted manually or remotely once the device is in position.

55. The device as claimed in claim 1, wherein said fibre optic cable is comprised of an optical fibre which comprises a silica fibre, wherein said optical fibre optionally comprises a silica core and silica cladding.

56. The device as claimed in claim 55, wherein the optical fibres are coated with a metal, wherein said metal optionally comprises aluminium, copper or gold.

57. The device as claimed in claim 1, wherein said fibre optic cable comprises a polymer optical fibre cable, wherein said polymer optical fibre cable optionally comprises poly(methyl methacrylate), polystyrene, or mixtures thereof

58. The device as claimed in claim 57, wherein the fibre optic cable is cased in a metal sheath, wherein said metal is optionally copper.

59. The device as claimed in claim 1, wherein the fibre optic cable is held in contact with the crystal by the use of securing means, wherein said securing means optionally comprises a metallic sheath, wherein said metallic sheath is optionally formed of aluminium.

60. The device as claimed in claim 1, wherein said fibre optic cables comprise fibre optic light filters, wherein said fibre optic light filters are optionally attached to the ends of the fibre optic cables which co-operate with the light detector and wherein said fibre optic light filters are optionally adapted to reduce the fibre optic output light intensity by between 50 and 99.99%.

61. The device as claimed in claim 50, wherein said Charged Coupling Device (CCD) camera is a back-thinned, Full Frame Transfer CCD image sensor of 16 bit digital output, wherein said camera optionally comprises a multiplicity of discrete ports.

62. The device as claimed in claim 1, for use in the monitoring of products, processes and facilities in the nuclear industry, wherein said device is optionally used for monitoring the processing, storage or movement of intermediate and high level wastes.

63. An array of detectors comprising a multiplicity of devices as claimed in claim 1.

64. A method for the detection of elevated levels of radiation in remote locations, said method comprising:
providing a device as claimed in claim 1 alone or in an array;
exposing said device to radiation such that scintillation light produced from the scintillation crystal is transmitted down the fibre optic cable;
detecting the scintillation light by means of a light detection device which co-operates with recording means;
recording the camera output on the recording means; and
determining the radiation levels of the environment in which the device is deployed, wherein said device is optionally manipulated into position by means of master slave manipulator operator arms.
